(19) United States
(12) Patent Application Publication
(10) Pub. No.: US 2017/0270265 A1
(43) Pub. Date: Sep. 21, 2017

(54) Medical Telecommunications Platform Accessing Electronic Health Records and Health Monitoring Devices

(71) Applicant: CRF, Inc., Plymouth Meeting, PA (US)

(72) Inventor: Richard Strobridge, Alpine, CA (US)

(73) Assignee: CRF, Inc., Plymouth Meeting, PA (US)

(21) Appl. No.: 15/460,634

(22) Filed: Mar. 16, 2017

Related U.S. Application Data
(60) Provisional application No. 62/308,867, filed on Mar. 16, 2016.

(51) Int. Cl. G06F 19/00

(52) U.S. Cl. CPC G06F 19/3418; G06F 19/322; G06F 19/3406; G06F 19/328; G06F 17/30991

(57) ABSTRACT

A system, a method and a computer program product for a web-based telecommunications platform to facilitate medical consultations between health care professionals and patients is disclosed. The system includes a web-based telecommunications platform with a dashboard that may be used by patients to upload pertinent medical information and health monitoring device data viewable by at least one medical professional. The dashboard applications of the telecommunications platform are customizable and may include for example patient EHRs, health monitoring device data, audio recordings of past and current consultations, prescription history, health insurance and background data.

### PRIORITY

This application claims priority of U.S. provisional application No. 62/308,867 filed on Mar. 16, 2016 and the contents of which is incorporated herein by reference.

### BACKGROUND OF THE INVENTION

1. Field of Invention

The present invention relates generally to remote healthcare encounters and more particularly to a platform of web-based telecommunications for use by patients to upload medical information and health monitoring device data viewable by at least one medical professional.

2. Description of Related Art

Telemedicine is advancing the way many physicians and hospitals exchange medical information with each other and their patients. The growth of telemedicine is being driven by technological advances in video conferencing, smartphones, wireless health monitoring devices, and other wireless technologies. These technologies have facilitated the use of telemedicine in a variety of ways such as remote patient monitoring, remote consultations, exchanging of medical information, and as an educational tool for patients and physicians alike. As such, there is improved access for those located in underserved areas, a reduction in the cost of healthcare, improved quality of care, and greater patient satisfaction.

One type of medical information exchanged between physicians, hospitals and patients is the patient's medical record. The electronic version of a patient's medical record has become known as an electronic medical record (EMR) or the broader more encompassing electronic health record (EHR). An EMR is simply the electronic version of the patient's paper medical record or chart for a particular clinic or physician. An EHR, on the other hand, is a much more comprehensive record of a patient's total health that includes all laboratory results, prescriptions, clinicians, etc. Moreover, the EHR is intended to be exchanged and updated between hospitals, clinics, and physicians to provide improved healthcare to the patient.

Although the exchange of medical information is becoming more commonplace in many hospitals and clinics, there exists a need for a web-based telecommunications platform that incorporates consultations, health monitoring device data, and a patient's EHR to improve the quality of care as well as better serve those in remote locations.

### SUMMARY OF THE INVENTION

The present invention overcomes these and other deficiencies of the prior art by providing a system and method including a medical telecommunication platform as used by physicians and patients to conduct consultations using dashboard applications. In an exemplary embodiment of the invention, the system includes a web-based telecommunications platform with a dashboard that may be used by patients to upload pertinent medical information and health monitoring device data viewable by at least one medical professional. The dashboard applications of the telecommunications platform are customizable to include, by way of non-limiting examples, patient EHRs, health monitoring device data, audio recordings of past and current consultations, prescription history, health insurance and background data, and the like

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, and the advantage thereof, reference is now made to the ensuing descriptions taken in connection with the accompanying drawings briefly described as follows:

FIGS. 1A and 1B illustrate a medical telecommunication platform as used by physicians and patients to conduct consultations using dashboard applications according to an embodiment of the invention;

FIG. 2 illustrates a medical telecommunications platform as used by physicians and patients as a standalone application or as an option in pre-existing telecommunication platforms according to an embodiment of the invention;

FIG. 3 illustrates a medical telecommunications platform's graphical user interface (GUI) as presented to a patient and a physician according to an embodiment of the present invention;

FIG. 4 illustrates a process flow chart for the execution of a medical telecommunications platform according to an embodiment of the invention;

FIG. 5 illustrates a process flow chart for accessing a medical telecommunications platform according to an embodiment of the invention;

FIG. 6 illustrates a process flow chart for commencing a medical telecommunications consultation according to an embodiment of the invention;

FIG. 7 illustrates a system and network implementing a medical telecommunications platform with databases, health monitoring devices, and connected devices according to an embodiment of the invention;

FIG. 8 illustrates an example process by which a patient retrieves data using the dashboard application of the medical telecommunications platform according to an embodiment of the invention;

FIGS. 9A and 9B illustrate an example process by which a patient retrieves health monitoring device data and modifies settings using the dashboard of the medical telecommunications platform according to an embodiment of the invention;

FIGS. 10A and 10B illustrate an example process by which a patient retrieves information using the dashboard of the medical telecommunications platform according to an embodiment of the invention;

FIG. 11 illustrates an example process by which a patient schedules a consultation using the dashboard of the medical telecommunications platform according to an embodiment of the invention; and

FIG. 12 illustrates an example process by which a plurality of health monitoring devices may be synched using the dashboard of the medical telecommunications platform according to an embodiment of the invention.

### DETAILED DESCRIPTION OF EMBODIMENTS

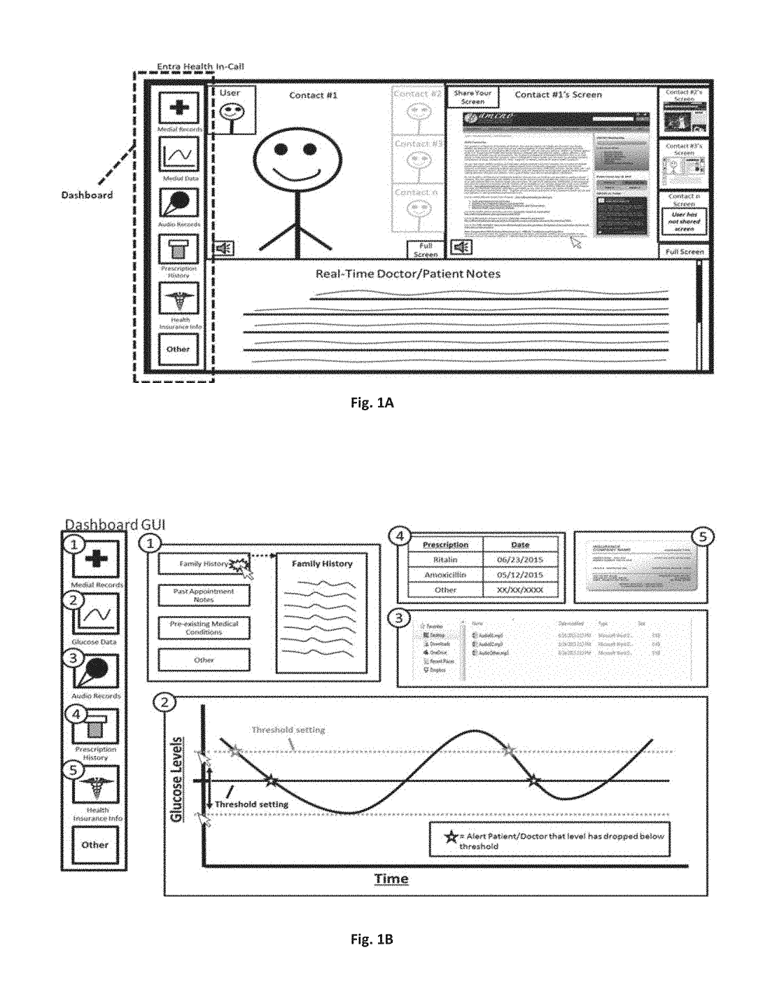

Further features and advantages of the invention, as well as the structure and operation of various embodiments of the invention, are described in detail below with reference to the accompanying FIGS. 1-12.

FIGS. 1A and 1B illustrate a medical telecommunication platform as used by physicians and patients to conduct consultations using dashboard applications according to an embodiment of the invention. In an exemplary embodiment of the invention, the system includes a web-based telecommunications platform with a dashboard that may be used by patients to upload pertinent medical information and health monitoring device data viewable by at least one medical professional. The dashboard applications of the telecommunications platform are customizable to include, by way of non-limiting examples, patient EHRs, health monitoring device data, audio recordings of past and current consultations, prescription history, health insurance and background data, and the like.

FIG. 1B is a representative GUI according to an embodiment of the invention. The applications of the dashboard may be viewable as individual windows in the GUI singularly or in any combination of the available dashboard applications. The parties to the medical consultation are therefore able to select which applications they would like to view while conducting the consultation. For example, the physician may select the patient's EHR and prescription history to recommend an appropriate therapy. Likewise, health monitoring devices may be linked to the system to supply data to assist the physician in assessing the patient's health. The health monitoring devices may be configured to alert the patient and/or the physician that certain parameters have been attained above or below a predetermined threshold.

The system of the present invention facilitates communications during a medical consultation between a plurality of medical professionals. All authorized parties to the consultation are able to view patient EHRs, data documents, background info, health monitoring device data, etc. Moreover, medical professionals and/or patients are able to log real-time notes regarding the current consultation as well as permitting the parties to the consultation to share with each other what is currently being displayed on their screen for instances when expanded explanation is needed.

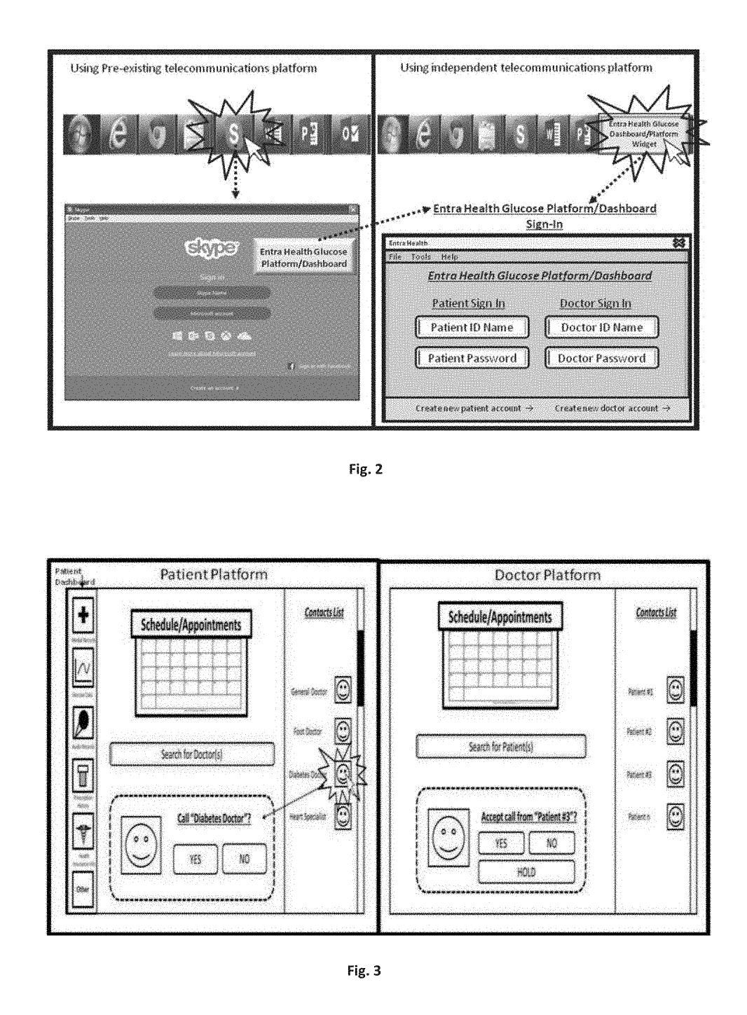

FIG. 2 illustrates a medical telecommunications platform as used by physicians and patients as a standalone application or as an option in pre-existing telecommunication platforms according to an embodiment of the invention. The medical telecommunications platform of the present invention may be implemented as an add-on to a pre-existing telecommunications platform. By way of non-limiting example, pre-existing telecommunications platforms may be any video conferencing service and/or voice over internet protocol (VoIP) such as Skype® or Google Hangouts®. Additionally, the medical telecommunications platform may be a standalone application executable from a networked device.

FIG. 3 illustrates a medical telecommunications platform's GUI as presented to a patient and a physician according to an embodiment of the present invention. FIG. 3 illustrates a representative GUI as viewed by the patient and physician. The representative patient/physician GUI illustrates various capabilities that may be presented to the patient/physician looking to conduct a medical consultation. For example, the patient may have any number of medical professionals categorized based upon the particular disease state or illness for which the medical professional is providing healthcare to the patient. The physician may categorize patient files according to his/her normal office procedures or link existing medical office software with the system of the present invention. In addition, the representative patient GUI may allow the patient to conduct a search of a database of medical professionals available to provide medical services. The database of medical professionals may be created from both in-network and out-of-network medical professionals associated with the patient's insurance carrier. Alternatively, the database of medical professionals may be created by the patient and/or physician to provide medical professionals that are available for medical telecommunication consultations in the event the patient's primary medical professional is unavailable. The patient's GUI may permit the patient to search and schedule both in-office and/or remote consultations. Remote consultations may be initiated by the physician or patient by selecting the appropriate party and executing a medical telecommunications consultation.

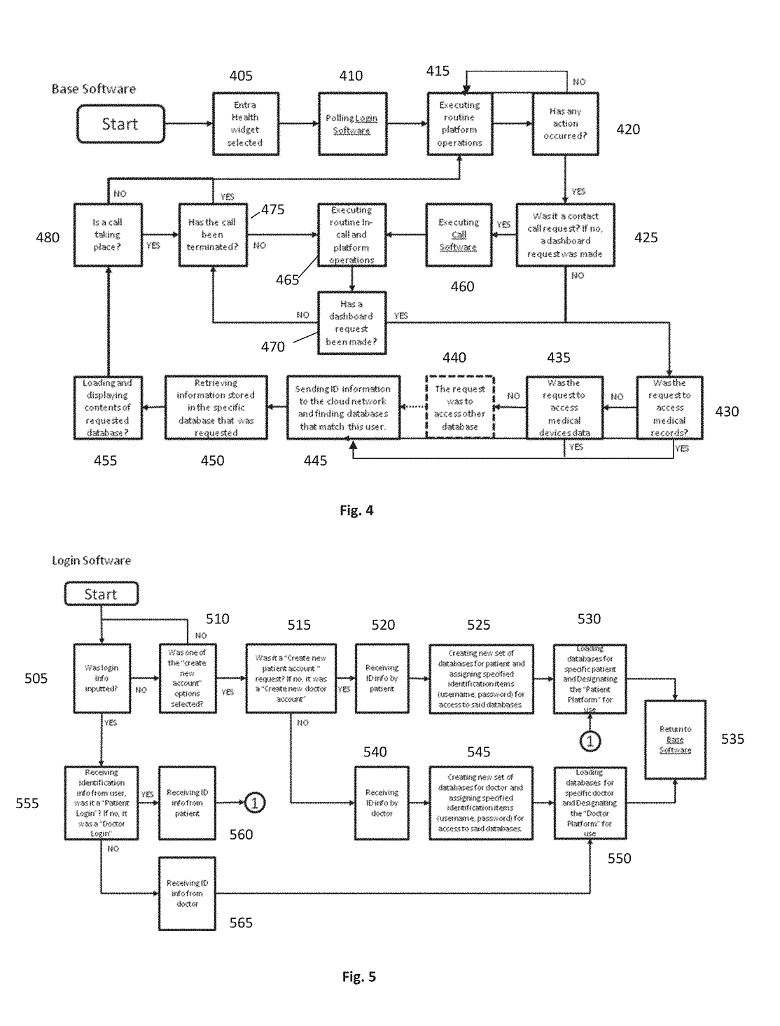

FIG. 4 illustrates a process flow chart for the execution of a medical telecommunications platform according to an embodiment of the invention. A user desiring to execute a medical telecommunications platform application would select at 405 the stand alone application of the present invention or select the application as an add-on to a pre-existing telecommunications platform. At 410, the user would enter identification information that may be in the form of a unique username and password combination or any predetermined/assigned identifying information. A GUI, as described with respect to FIGS. 1A and 1B, is presented to the user to execute any number of applications, step 415, associated with the dashboard of the platform. The system, at 420, determines whether the user has selected a dashboard application for execution. If the system determines that the user has not selected a dashboard application for execution, then the process returns to step 415 and continues this cycle until the user selects a dashboard application. At 425, the system determines whether the selected dashboard application was a request to execute a medical consultation. If the user is not executing a medical consultation, then at 430, the system determines whether the user has selected a dashboard application for access to EHRs. In the alternative, the system, at 435, determines whether the user has selected a dashboard application for accessing health monitoring device data. The system, at 440, may continue to determine whether the user has selected any of the dashboard applications available through the user's GUI. If at 430, 435, or 440, the system determines requests were made to access available dashboard applications, the system, at 445, sends the user's identifying information to the network to locate the relevant databases for the requested dashboard applications. At 450, the requested information is retrieved from the relevant database and, at 455, loaded and displayed on the user's GUI.

If the user is requesting to execute a medical consultation, then at 460, the system executes a consultation with the user selected party. The system may facilitate the consultation with a proprietary telecommunications platform as described herein or the consultation may be had via a pre-existing telecommunications platform such as any videoconferencing platform or Von' such as Skype® or Google Hangouts®. During the consultation, at 465, the system performs in-call routines, which may include executing scheduling, note taking, audio recordings, etc. In addition, at 470, the system will continuously determine whether the user requests access to any of the available dashboard applications. If requests are made by the user to access any of the available dashboard applications, then the process continues at 430 as described above. If the user has not requested access to any of the available dashboard applications, then at 475, the system determines whether the consultation has been terminated. Once the requested dashboard application information is retrieved from the relevant database, at 455, and loaded and displayed on the user's GUI, the system determines, at 480, whether the consultation is ongoing. If the consultation is not ongoing or if the user has terminated the consultation, the process returns to 415 to determine whether any platform routines are being executed.

FIG. 5 illustrates a process flow chart for accessing a medical telecommunications platform according to an embodiment of the invention. The system of the present invention includes a software module configured to create a user account permitting the user to access the medical telecommunications platform. A user desiring to access the medical telecommunications platform, at 505, will input unique identifying information if the user has previously created an account within the system. If the user did not previously create an account, then at 510, the user may select to create a new account. For the purposes of this representative process flow, the users described with respect to FIG. 5 will be a patient and a physician. It is understood, however, that the system may include additional users. By way of non-limiting examples, the users may include a pharmacist, nutritionist, dentist, a physician assistant, a nurse practitioner, a registered nurse, a chiropractor, a psychologist, a physical therapist, an occupational therapist, a speech therapist, a radiology technician, and the like.

The system, at 515, determines whether the user account being created is a patient account or a physician account. If the account being created is a patient account, then at 520, the system receives identifying information from the patient. The system, at 525, creates a database associated with the unique identifying information corresponding to this patient, e.g., a username and password. The patient is now enrolled in the system for accessing and using the medical telecommunications platform. The patient, at 530, is then able to begin populating the database associated with their account with background information, EHR, health monitoring devices, prescription information, etc. The patient may accomplish this by entering the data manually; linking to the various sources of the data whereby internal software modules facilitate the transfer; or by means known to those of skill in the art. The patient may then, at 535, begin using the system as described with respect to FIG. 4 and more specifically at step 415.

If the account being created is a physician account, then at 540, the system receives identifying information from the physician. The system, at 545, creates a database associated with the unique identifying information corresponding to this physician, e.g., a username and password. The physician is now enrolled in the system for accessing and using the medical telecommunications platform. The physician, at 550, is then able to begin populating the database associated with their account with background information, EHRs, health monitoring devices, prescription information, etc., for the patients attended to by the physician that are also enrolled in the system. The physician may accomplish this by entering the data manually; linking to the various sources of the data whereby internal software modules facilitate the transfer; or by means known to those of skill in the art. The physician may then, at 535, begin using the system as described with respect to FIG. 4 and more specifically at step 415.

In some cases, the user is already an enrolled patient or physician. In this case, at 505, the user would enter their unique identifying information, e.g., a username and password, and the system would receive the unique identifying information at 555. If the unique identifying information is that of a patient, then at 560, the system continues the process flow as illustrated at step 530. In the event the unique identifying information is that of a physician, then at 565, the system continues the process flow as illustrated at step 550.

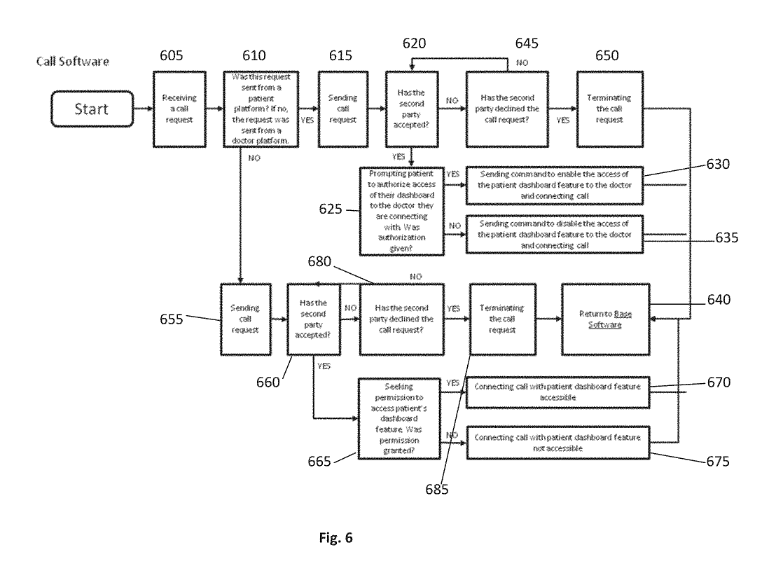

FIG. 6 illustrates a process flow chart for commencing a medical telecommunications consultation according to an embodiment of the invention. The system of the present invention includes a software module configured to permit the user to commence a medical telecommunications consultation. After a user has accessed the system through their user account, the user can request to place a call to commence a medical telecommunications consultation at 605. For the purposes of this representative process flow, the users described with respect to FIG. 6 will be a patient and a physician. It is understood, however, that the system may include additional users. By way of non-limiting examples, the users may include a pharmacist, nutritionist, dentist, a physician assistant, a nurse practitioner, a registered nurse, a chiropractor, a psychologist, a physical therapist, an occupational therapist, a speech therapist, a radiology technician, and the like.

The system, at 610, determines whether the request was from a patient or a physician. If the request was from a patient, then at 615, the request is sent to the party to which the patient has designated to consult with via the medical telecommunications platform. The system determines whether the designated party has accepted the consultation request at 620. With respect to this example, the patient is seeking a medical consultation with a physician. After the physician accepts the request to conduct a medical telecommunications consultation, the patient, at 625, authorizes the physician to access the patient's dashboard. If the patient authorizes the physician to access the patient's dashboard, then at 630, the physician is able to view the information associated with the patient's dashboard during the consultation, such as EHRs, health monitoring data, prescription history, etc. If, however, the patient does not authorize the physician to access the patient's dashboard, then at 635, the physician is unable to view the information associated with the patient's dashboard and the call proceeds accordingly or is terminated. In either instance, the patient and physician can return, at 640, to executing routine platform operations as described in FIG. 4.

As an alternative to accepting the request to commence a consultation at 620, the designated party, in this example a physician, may decide to decline the request at 645. In this event, the request to commence a medical telecommunications consultation is terminated 650 and the user may return, at 640, to executing routine platform operations as described in FIG. 4.

The process flow is similar for a physician initiated request. At 655, the physician may send a request to initiate a medical telecommunications consultation with at patient. If at 660 the patient accepts the request, then the physician may seek authorization, at 665, to access the patient's dashboard. If the patient authorizes the physician to access the patient's dashboard, then at 670, the physician is able to view the information associated with the patient's dashboard during the consultation, such as EHRs, health monitoring data, prescription history, etc. If, however, the patient does not authorize the physician to access the patient's dashboard, then at 675, the physician is unable to view the information associated with the patient's dashboard and the call proceeds accordingly or is terminated.

As an alternative to accepting the request to initiate a consultation at 660, the patient may decide to decline the request at 680. In this event, the request to initiate a medical telecommunications consultation is terminated 685 and the user may return, at 640, to executing routine platform operations as described in FIG. 4.

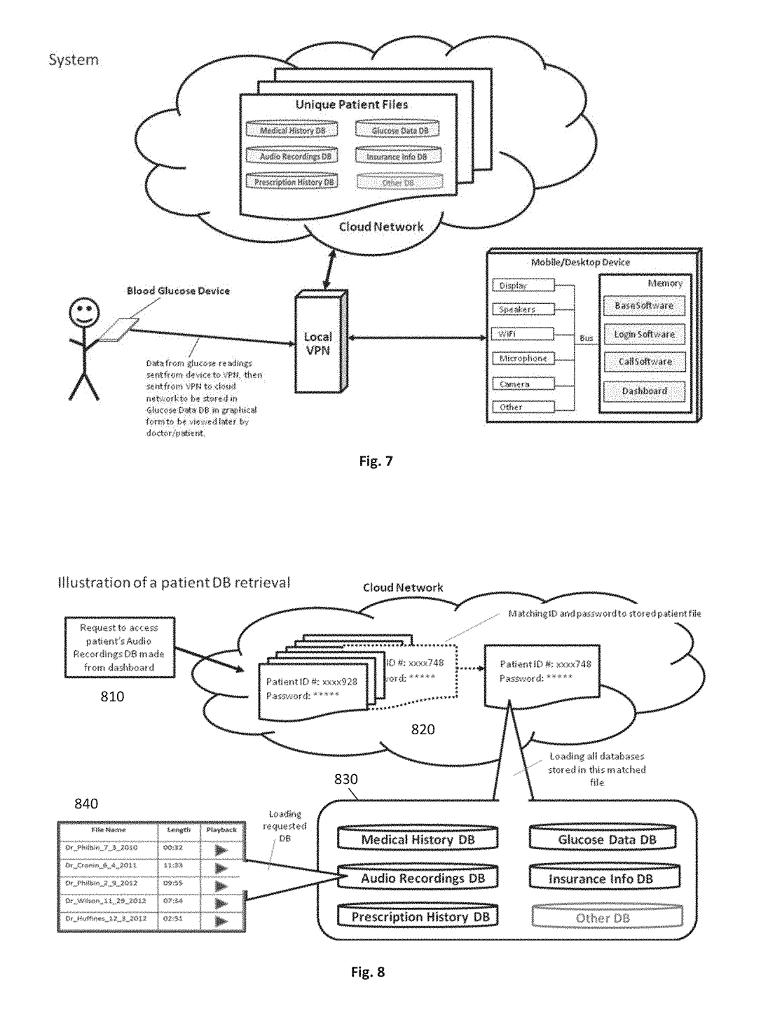

FIG. 7 illustrates a system and network implementing a medical telecommunications platform with databases, health monitoring devices, and connected devices according to an embodiment of the invention. The system of the present invention provides a web-based medical telecommunications platform that allows for EHRs, background information, and health monitoring device data, among other data, with respect to a specific patient, to be uploaded to a database and stored for current and/or future medical telecommunications consultations with a medical professional. FIG. 7 illustrates an overview of the system wherein health monitoring device data (illustrated here as blood glucose data) is sent over a network to a cloud network for storage in a designated database. For example, the system may have databases for EHRs, health monitoring device data, prescription history, audio recordings of past medical telecommunications consultations and/or physician/patient dictated notes, patient background information and the like. One of ordinary skill in the art will understand the implementation and configuration of such databases. A technology device is connected to the network and has a plurality of software modules configured to implement the various embodiments of the system as described herein. By way of non-limiting examples, the technology device may be smartphone, tablet, computer, and/or laptop including software modules configured to execute a patient or physician medical telecommunications platform and associated dashboard applications as described herein.

FIG. 8 illustrates an example process by which a patient retrieves data using a dashboard application of the medical telecommunications platform according to an embodiment of the invention. For ease of explanation, the following description with respect to FIG. 8 will be in the context of a patient and/or physician accessing and retrieving audio recordings from a database of the system of the present invention. It is to be understood that the same description may be applied to accessing and retrieving any data from a plurality of databases associated with the system of the present invention.

To initiate a request for access and retrieval of audio recordings of stored medical telecommunications consultations from a database of the system, at 810, a patient would select the audio recordings application from the patient's dashboard platform. Using predetermined unique identifying information, such as a username and password, the system would match, at 820, the patient identifying information with stored patient identifying information in a database of the system. The plurality of databases associated with this patient's unique identifying information would be loaded 830 and available to the patient for selection of the requested database—here the audio recordings database. At 840, the patient is then able to view the contents of the audio recordings database and select the file of their choosing. If the patient has authorized a physician to access the patient's dashboard platform, then the physician would have access to the audio recording file selected by the patient. In some embodiments, the patient can designate and/or restrict what information located within the patient's databases is accessible to medical personal. In some embodiments, authorization given by the patient can be on an as needed basis or by agreement between relevant parties.

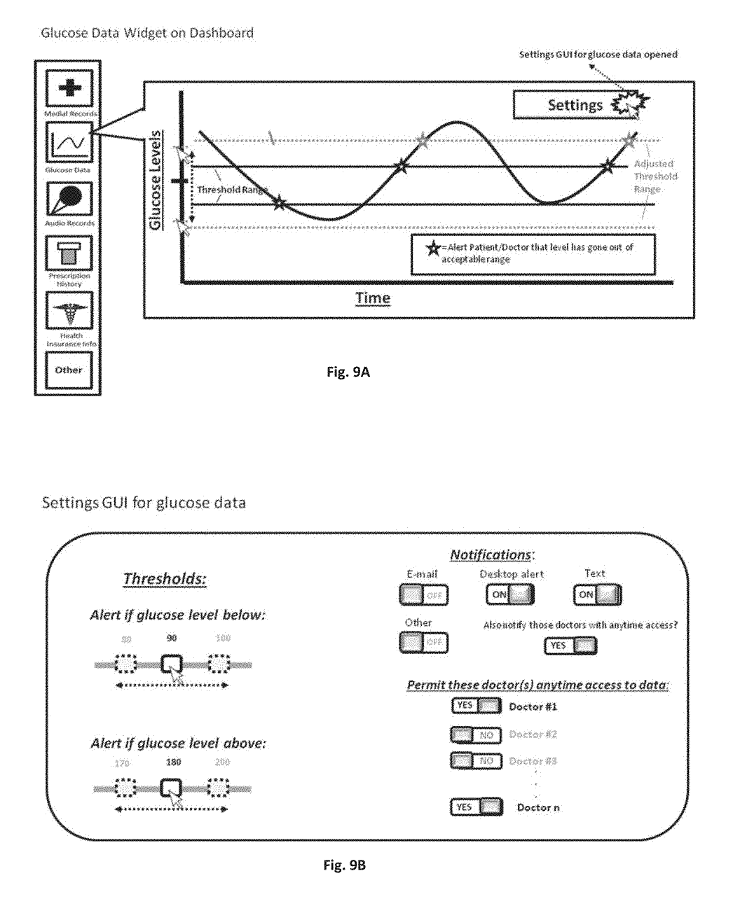

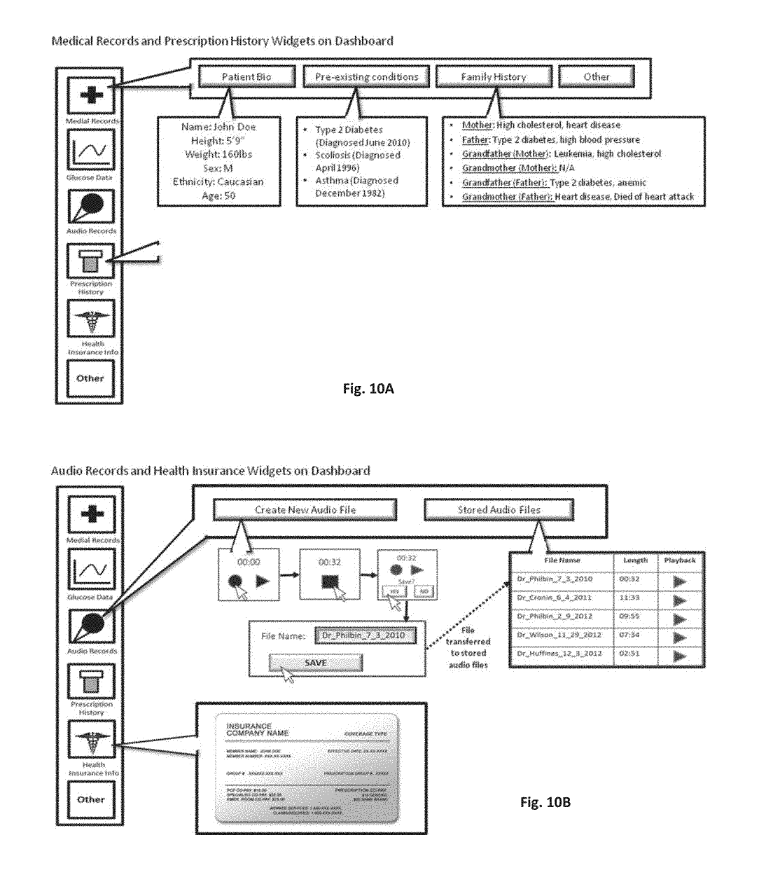

FIGS. 9A and 9B illustrate an example process by which a patient retrieves health monitoring device data and modifies settings using the dashboard of the medical telecommunications platform according to an embodiment of the invention. The system of the present invention is configurable to include a plurality of health monitoring devices. The plurality of devices are included as applications within the dashboard of the medical telecommunications platform. For example, in FIG. 9A a non-limiting example is depicted wherein a glucose meter communicates with the system to upload glucose data, which is viewable from an application for the glucose meter in the dashboard of the platform. By way of a non-limiting example, FIG. 9A depicts a user selection of the glucose meter application from the dashboard of the platform to show a graphical representation of the patient's glucose levels. The glucose meter application may be configured to allow a plurality of settings such as, but not limited to, thresholds, alerts, notifications, and authorizations. FIG. 9B illustrates a non-limiting representation of the settings for a glucose application in the dashboard of the system. A patient and/or physician may set thresholds for the patient's glucose levels and an alert if those levels exceed or fall below the preset thresholds. In addition, the patient and/or physician may set notifications be sent to various technology devices and/or individuals by way of email, text message, etc. The patient has the ability to designate which medical personnel are authorized to view the health monitoring device data. For example, the patient may authorize his/her primary care physician to view data collected from the patient's glucose meter. The primary care physician, in consultation with the patient, may set thresholds of 90 mg/dL and 180 mg/dL and elect to have alerts sent to the primary care physician and/or other parties if the patient's glucose levels exceed or fall below the preset thresholds. The alerts may be designated to be sent by way of a desktop alert and/or text message.

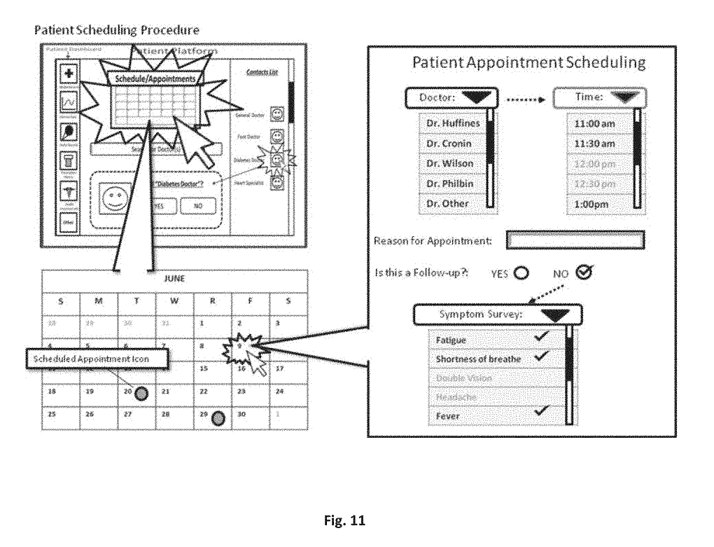

FIGS. 10A and 10B illustrate an example process by which a patient retrieves information using the dashboard of the medical telecommunications platform according to an embodiment of the invention. The system of the present invention is configurable to include a plurality of dashboard applications. FIG. 10A illustrates a non-limiting representation of and embodiment of the dashboard of the present invention. The plurality of dashboard applications may include EHRs, health monitoring device data, audio recordings, prescription history, health insurance information, and the like. A user selects the dashboard application of interest and the process flow as described with respect to FIG. 4 herein is initiated. FIG. 10A illustrates, by way of non-limiting example, the types of data that may be viewed when a user selects to see EHR data and prescription history data. Within each category of data, there can be a plurality of sub-categories configurable by one of ordinary skill in the art. For example, as illustrated in the non-limiting example of FIG. 10A, EHR data can be sub-categorized as patient biography, pre-existing conditions, family history, and the like. In addition, in some embodiments, the dashboard applications of the present invention may include additional functionality corresponding to a particular dashboard application. For example, FIG. 10B illustrates the additional functionality associated with the audio recordings dashboard application. A user can create recordings and/or review previously stored audio files. In some embodiments, the dashboard application is a video/audio recording such that the medical telecommunications consultation is recorded as a video/audio file the implementation of which is known to those of skill in the art.

FIG. 11 illustrates an example process by which a patient schedules a consultation using the dashboard of the medical telecommunications platform according to an embodiment of the invention. In an embodiment of the invention FIG. 11, the dashboard platform includes a scheduling application permitting the user to schedule appointments with a plurality of medical professionals. The user can designate a time and date for the medical telecommunications consultation. The scheduling is dependent upon the availability of the medical professional. The user is able to define the reason for the request as well as symptoms resulting in the need for the requested consultation. The dashboard scheduling application is configurable by each of the plurality of medical professionals according to each of their administrative practices.

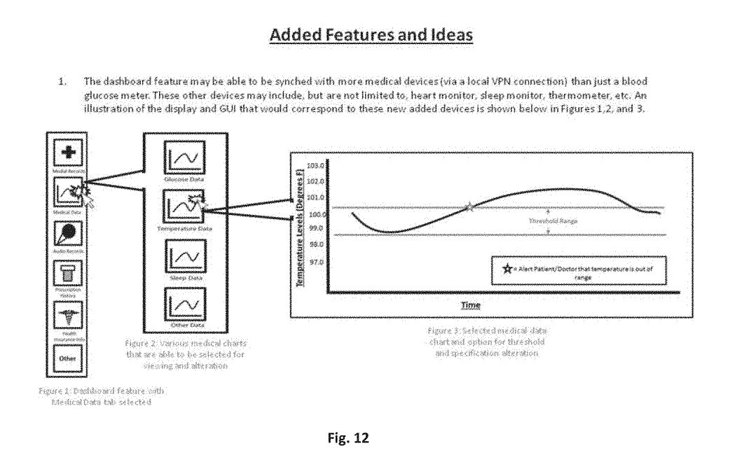

FIG. 12 illustrates an example process by which a plurality of health monitoring devices may be synched using the dashboard of the medical telecommunications platform according to an embodiment of the invention. FIG. 12 illustrates an embodiment of the present invention wherein the dashboard is configurable to include a plurality of health monitoring devices, including but not limited to, a glucose meter, heart monitor, sleep monitor, thermometer, and the like. Each of the plurality of health monitoring devices will be associated over a network to a database corresponding to the patient for the storage of health monitoring device data (see FIG. 8). As with the glucose meter discussed herein, the patient and/or physician may set thresholds and alerts relevant to the type and capabilities of each of the plurality of health monitoring devices in communication with the system of the present invention.

Those of skill in the art will appreciate that the various illustrative logical blocks, modules, units, and algorithm steps described in connection with the embodiments disclosed herein can often be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular constraints imposed on the overall system. Skilled persons can implement the described functionality in varying ways for each particular system, but such implementation decisions should not be interpreted as causing a departure from the scope of the invention. In addition, the grouping of functions within a unit, module, block, or step is for ease of description. Specific functions or steps can be moved from one unit, module, or block without departing from the invention.

The various illustrative logical blocks, units, steps and modules described in connection with the embodiments disclosed herein, and those provided in the accompanying documents, can be implemented or performed with a processor, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein, and those provided in the accompanying documents. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm and the processes of a block or module described in connection with the embodiments disclosed herein, and those provided in the accompanying documents, can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC. Additionally, device, blocks, or modules that are described as coupled may be coupled via intermediary device, blocks, or modules. Similarly, a first device may be described a transmitting data to (or receiving from) a second device when there are intermediary devices that couple the first and second device and also when the first device is unaware of the ultimate destination of the data.

The above description of the disclosed embodiments, and that provided in the accompanying documents, is provided to enable any person skilled in the art to make or use the invention. Various modifications to these embodiments will be readily apparent to those skilled in the art, and the generic principles described herein, and in the accompanying documents, can be applied to other embodiments without departing from the spirit or scope of the invention. Thus, it is to be understood that the description and drawings presented herein, and presented in the accompanying documents, represent particular aspects and embodiments of the invention and are therefore representative examples of the subject matter that is broadly contemplated by the present invention. It is further understood that the scope of the present invention fully encompasses other embodiments that are, or may become, obvious to those skilled in the art and that the scope of the present invention is accordingly not limited by the descriptions presented herein, or by the descriptions presented in the accompanying documents.

Accordingly, it is an object of this invention to provide a system including a medical telecommunications platform for facilitating a consultation using a plurality of dashboard applications as shown in FIGS. 1, 2, 3, 4, 5, 6, 7, 8, 9, 10, 11, and/or 12. It is a further object of this invention to provide a method for facilitating a consultation using a plurality of dashboard applications via a medical telecommunications platform as shown in FIGS. 1, 2, 3, 4, 5, 6, 7, 8, 9, 10, 11, and/or 12.

Yet another object of this invention is to provide a computer program product embodied on a computer readable storage medium comprising instructions executable by one or more processors configured to enable telecommunications platform with a dashboard for facilitating medical consultation between patients and doctors as shown in FIGS. 1-12.

What is claimed is:

1. A computer implemented system for a web based telecommunications platform for consultations between healthcare professionals and patients by using dashboard applications, said system comprising:
a telecommunications network;
a plurality of databases on remote servers capable of being modified;
at least two user computing devices comprising a display and user input device, at least one of the devices being operated by a patient and at least one operated by a healthcare professional;
at least one health monitoring device connected to the system;
a multitude of software modules stored on computer readable media and comprising instructions executable by at least one processor and interacting with each other to:
a) permit setting up a patient account for a patient user and associating one or more databases with the patient account and setting up a doctor account for a healthcare professional user and associating one or more databases with the doctor account;
b) permit the patient user to populate the one or more databases associated with the patient account with patient information, and permit the healthcare professional user to populate the one or more databases associated with the doctor account with information of healthcare professional's patients enrolled in the system;
c) permit the patient user to upload data from the at least one health monitoring device to the at least one database associated with the patient account;
d) display a graphical user interface (GUI) for a customizable dashboard on the patient user device display;
e) permit the patient user to commence a medical consultation by initiating a web based audio or video telecommunication call to the healthcare professional, and permit the healthcare professional initiate a web based audio or video telecommunication call to the patient, and permit the patient user to allow the healthcare professional an access to the dashboard during the consultation;
f) permit the patient or the healthcare professional user to select an application from the dashboard during the consultation to search and retrieve information stored on the at least one database associated with the patient account and present the information on the user device displays during the consultation; and
g) permit the patient or the healthcare professional user to select an application from the dashboard to make real time notes during the consultation and/or audio- or video-record the consultation and store the notes and/or recordation in the one or more databases associated with the patient account.

2. The system of claim 1, wherein the health monitoring device is selected from a glucose meter, a heart monitor, a sleep monitor, and a thermometer.

3. The system of claim 1, wherein the patient user or the healthcare professional user is permitted to select an application from the dashboard to define a plurality of settings for the health monitoring device, the settings being selected from thresholds, alerts, notifications and authorizations.

4. The system of claim 3, wherein the patient user or the healthcare professional user is permitted to select an application from the dashboard to set an alert to be send to one or more technical devices when a health related parameter measured with the health monitoring device is below or above a predetermined threshold.

5. The system of claim 4, wherein the technical device is a computer, a cell phone, a smart phone, or a smart watch.

6. The system of claim 1, wherein the one or more databases contain patient electronic health records, patient family history, patient insurance information, information of medical professionals treating various conditions, and/or information of medical professionals accepting patient's insurance policy.

7. The system of claim 1, wherein the users can select the telecommunications platform from a stand-alone application executable from a networked computing device and a pre-existing video conferencing service or voice over internet protocol.

8. The system of claim 1, wherein additional users may be included in the system.

9. A method for facilitating consultations between patients and healthcare professionals via a web based medical telecommunications platform, the platform comprising software modules executable by at least one processor and configured to transfer information from one or more user computing devices into at least one database on one or more remote servers and to execute a web based audio- or video telecommunications call between at least one patient and at least one healthcare professional, said method comprising:
associating at least one database to a patient account accessible by the patient via a user computing device, and at least one database to doctor account accessible by the healthcare professional via a computing device;
uploading patient information into the database associated with the patient account;
uploading patient health related data from at least one health recording device connected with a user computing device into the database associated with the patient account;
either a patient or a healthcare professional initiating the web based telecommunications call;
during the web based telecommunications call, the patient providing an access to the healthcare professional to a dashboard displayed on the patient user's computing device display;
the patient or the healthcare professional selecting from the dashboard an application to record the consultation and store the recordation in the database.

10. The method of claim 9, wherein during the call the healthcare professional or the patient selecting an application from the dashboard to define threshold values for parameters measured with the at least one health recording device, and selecting to send a notification to one or more technology devices when a health recording device reading is higher or lower than the selected threshold value.

11. The method of claim 10, wherein the at least one health recording device is selected from glucose meter, heart monitor, sleep monitor, and a thermometer.

12. The method of claim 9, wherein the user can select the telecommunications platform from a stand-alone application executable from a networked computing device and a pre-existing video conferencing service or voice over internet protocol.

13. A computer program product embodied on a computer readable storage medium, the computer program product comprising instructions executable by one or more processors to:
enable setting up a patient account, associating at least one database in one or more remote servers with the patient account, and a patient user signing in to the account;
enable setting up a doctor account, associating one or more patient databases in one or more remote servers with the doctor account, and a healthcare professional user signing in to the account;
enable the patient user and the healthcare professional user to populate the databases associated with their accounts with patient information;
enable the patient user to transfer information from at least one health recording device connected with patient's computing device to the at least one database associated with patient account;
enable either the patient or the healthcare professional to initiate a web based telecommunications consultation between the patient and the healthcare professional;
present a GUI for a dashboard on patient user's computing device display and enable the patient to provide an access to the healthcare professional user to the dashboard;
enable the patient user and the healthcare professional user to select from the dashboard applications to search and retrieve information from the one or more patient databases and display the information on the user device display, to make real time notes and/or audio- or video record the consultation, and store the notes and recordation in the patient database.

14. The computer program product of claim 13, wherein the product comprises instructions executable by one or more processors to define a plurality of settings for the health monitoring device selected from thresholds, alerts, notifications and authorizations.

15. The computer program product of claim 14, wherein the product comprises instructions executable by one or more processors to permit a selection from the dashboard for an application to send an alert to one or more technical devices when a health related parameter measured with the at least one health monitoring device is below or above a predetermined threshold.
